(19) United States
(12) Patent Application Publication
(10) Pub. No.: US 2026/0273475 A1
(43) Pub. Date: Sep. 17, 2026

(54) HIGH-PRESSURE REVERSE OSMOSIS MEMBRANE BASED ON PECTIN-ASSISTED INTERFACIAL POLYMERIZATION AND PREPARATION METHOD THEREFOR

(71) Applicants: Tiangong University, Tianjin (CN); Shandong Industrial Institute of Seawater Desalination and Multipurpose Utilization, Shandong (CN)

(72) Inventors: Na Chang, Tianjin (CN); Haitao Wang, Tianjin (CN); Ligang Lin, Tianjin (CN); Quan Kang, Jinan City (CN); Zhaojing Jing, Tianjin (CN); Yanjun Jia, Tianjin (CN); Wei Shao, Tianjin (CN)

(73) Assignees: Tiangong University, Tianjin (CN); Shandong Industrial Institute of Seawater Desalination and Multipurpose Utilization, Shandong (CN)

(21) Appl. No.: 19/409,761

(22) Filed: Dec. 5, 2025

(30) Foreign Application Priority Data
Mar. 13, 2025 (CN) 202510296953.5

(51) Int. Cl. B01D 69/12; B01D 61/02; B01D 67/00; B01D 71/08; B01D 71/66; C02F 1/44; C02F 103/08; C08J 7/04; C09D 7/20; C09D 7/65; C09D 177/06

(52) U.S. Cl. CPC B01D 69/1251; B01D 61/025; B01D 67/0006; B01D 67/0083; B01D 67/0095; B01D 71/08; B01D 71/66; C02F 1/441; C08J 7/0427; C09D 7/20; C09D 7/65; C09D 177/06; B01D 2323/081; C02F 2103/08; C02F 2301/066; C08J 2381/06; C08J 2405/06; C08J 2477/06

(57) ABSTRACT

A method for preparing a high-pressure reverse osmosis membrane based on pectin-assisted interfacial polymerization includes the following steps: (1) fixing a polysulfone ultrafiltration membrane to an organic glass frame, and removing liquid drops from a surface of the polysulfone ultrafiltration membrane; (2) pouring an aqueous solution containing metaphenylenediamine, camphorsulfonic acid, triethylamine and pectin onto the surface of the polysulfone ultrafiltration membrane, and removing a residual aqueous phase solution after allowing the polysulfone ultrafiltration membrane to stand for a period of time; (3) pouring an organic solution containing trimesoyl chloride onto the surface of the membrane obtained in step (2), and removing a residual organic phase solution after allowing the polysulfone ultrafiltration membrane to stand for a period of time; and (4), subjecting the membrane obtained in step (3) to standing, thermal treatment, and pure water washing in sequence to obtain the high-pressure reverse osmosis membrane.

### CROSS-REFERENCE TO RELATED APPLICATION

This application claims the priority benefit of China application serial no. 202510296953.5, filed on Mar. 13, 2025. The entirety of the above-mentioned patent application is hereby incorporated by reference herein and made a part of this specification.

### BACKGROUND

### Technical Field

The present disclosure relates to the technical field of preparation of high-pressure reverse osmosis membranes, and in particular, to a high-pressure reverse osmosis membrane based on pectin-assisted interfacial polymerization and a preparation method therefor.

### Description of Related Art

An aromatic polyamide (PA) thin film composite (TFC) membrane is the most advanced commercial reverse osmosis membrane. A PA separating layer having a desalination function is formed by rapidly crosslinking metaphenylenediamine (MPD) and trimesoyl chloride (TMC) as reaction monomers on a surface of a polysulfone (PSF) supporting membrane through an interfacial polymerization (IP) reaction. As a special reverse osmosis membrane, a high-pressure reverse osmosis membrane is applied to a condition with an extremely high pressure (5.52 MPa) and salinity (32,000 mg/L NaCl), and has better water permeability and permeation selectivity. However, since the aromatic PA separating layer of the high-pressure reverse osmosis membrane typically has irregular and discontinuous sub-nanometer transmission channels, there is a trade-off “seesaw” phenomenon between the water permeability and the separating selectivity, i.e., the “Trade-off” effect. Therefore, the preparation of the high-pressure reverse osmosis membrane faces a huge challenge in considering both high permeability and selectivity.

By precisely regulating the thickness, pore size distribution, hydrophilicity, and charging property of the aromatic PA separating layer, the desalinization ratio and the water permeation flux of the high-pressure reverse osmosis membrane can be adjusted. However, due to a high diffusion rate of reaction monomers and a severe interfacial polymerization reaction, the aromatic PA separating layer has a multi-scale structure that is extremely compact but is non-uniform. The thickness of the aromatic PA separating layer is usually greater than 250 nm and is difficult to regulate, so that the improvement of the water permeability is restricted. On the other hand, in the presence of interaction forces between the reaction monomers which are hardly dispersed uniformly, the high-molecular chain structure of PA formed is high in randomness, resulting in a larger (usually 4-5.8 Å) free volume (pore size) and a wide pore size distribution of the PA separating layer, and thus, the desalinization ratio is hardly further improved. To sum up, breaking through the “Trade-off” effect between the water permeability and the separating selectivity becomes a bottleneck problem that restricts the improvement of the performance of the reverse osmosis membrane, in particular, the high-pressure reverse osmosis membrane.

By adjusting the distribution and diffusion of the reaction monomers, regulating the interfacial polymerization reaction rate, and improving the orderliness of the interfacial polymerization reaction, reducing the thickness of the membrane becomes an effective strategy and ideal for breaking through the “Trade-off” effect while narrowing the pore size distribution. As a natural high-molecular polymer, pectin is a typical anionic heteropolysaccharide widely existing in pericarps of oranges, lemons, and shaddocks. Since the molecular structure is rich in hydroxyl and carboxyl, pectin has good hydrophilicity. In addition, as a common food thickener, pectin can significantly improve the viscosity of the liquid.

### SUMMARY

To solve the problem of the “trade-off” effect between the permeation flux and the retention rate of a high-pressure reverse osmosis membrane, the present disclosure provides a high-pressure reverse osmosis membrane based on pectin-assisted interfacial polymerization and a preparation method therefor. By using pectin as an additive for an aqueous phase solution of an interfacial polymerization reaction, the viscosity of the aqueous phase solution is increased, the diffusion rate of PMD to an organic phase is slowed down, and the depth of a miscible zone of the interfacial polymerization reaction is reduced, so that the thickness of a PA separating layer is decreased. At the same time, by weakening the interaction between the reaction monomers of the MPD in the aqueous phase solution, the dispersing uniformity of the MPD is improved, and the orderliness of the interfacial polymerization reaction and the entangling regularity of a polyamide high-molecular chain are improved, so that the stacking density of PA is improved, the pore size distribution is narrowed, and the porous structure is optimized. In addition, rich functional groups in the molecular structure of pectin can endow the PA separating layer with higher hydrophilicity and charging property, which is beneficial to further improving the permeation selectivity of the high-pressure reverse osmosis membrane.

The present disclosure is realized as follows: a method for preparing a high-pressure reverse osmosis membrane based on pectin-assisted interfacial polymerization includes the following steps:
(1) fixing a polysulfone ultrafiltration membrane to an organic glass frame, and draining off water drops on a surface of the polysulfone ultrafiltration membrane;
(2) pouring an aqueous solution containing metaphenylenediamine, camphorsulfonic acid, triethylamine and an interfacial polymerization reaction regulator onto the surface of the polysulfone ultrafiltration membrane, and removing a residual aqueous phase solution after allowing the polysulfone ultrafiltration membrane to stand for a period of time, where the interfacial polymerization reaction regulator is pectin, with a mass percent of 0.05-0.3 wt %;
(3) pouring an organic solution containing trimesoyl chloride onto the surface of the membrane obtained in step (2), and removing a residual organic phase solution from the surface after allowing the polysulfone ultrafiltration membrane to stand for a period of time; and
(4) allowing the membrane obtained in step (3) to stand, putting the membrane in an air blast drying oven after the residual solution on the surface is naturally volatilized, performing a thermal treatment for a period of time at a specific temperature, and washing the surface of the membrane with deionized water to remove a residue from the surface to obtain the high-pressure reverse osmosis membrane.

Preferably, in step (1), a pure water permeation flux of the polysulfone ultrafiltration membrane at 0.1 MPa is 400-500 L·m⁻²·h⁻¹, and a bovine serum albumin retention rate of the polysulfone ultrafiltration membrane is 90.1-90.3%.

Preferably, in the aqueous solution in step (2), a mass percent of metaphenylenediamine is 1.5-4 wt %, a mass percent of camphorsulfonic acid is 2-3.5 wt %, a mass percent of triethylamine is 0.8-2 wt %, the mass percent of pectin is 0.05-0.3 wt %, and a solvent for the aqueous solution is deionized water.

Preferably, in the aqueous solution in step (2), a mass percent of metaphenylenediamine is 2.8 wt %, a mass percent of camphorsulfonic acid is 2.8 wt %, a mass percent of triethylamine is 1.3 wt %, and the mass percent of pectin is 0.05-0.3 wt %.

Preferably, in step (2), the polysulfone ultrafiltration membrane stands for 30-50 s.

Preferably, in the organic solution in step (3), a mass percent of trimesoyl chloride is 0.1-0.25 wt %, and a solvent for the organic solution is one or more of normal hexane, isopar G, isopar H, isopar L, and isopar M.

Preferably, in the organic solution in step (3), a mass percent of trimesoyl chloride is 0.17 wt %, and a solvent for the organic solution is normal hexane.

Preferably, in step (3), the polysulfone ultrafiltration membrane stands for 30-50 s.

Preferably, in step (4), a temperature of the air blast drying oven is 80-120° C., and the thermal treatment is performed for 100-300 s.

Further preferably, the temperature of the air blast drying oven is 95° C., and the thermal treatment is performed for 190 s.

A high-pressure reverse osmosis membrane based on pectin-assisted interfacial polymerization is prepared by the above preparation method.

The 32000 mg/L NaCl retention rate at 5.52 MPa of the high-pressure reverse osmosis membrane reaches 99.57%, and the permeation flux reaches 80.15 L·m⁻²·h⁻¹.

The present disclosure has the following advantages and positive effects:

In the present disclosure, in order to improve the permeation flux and the permeation selectivity of the high-pressure reverse osmosis membrane, pectin is used as an assistant interfacial polymerizer, which has the following advantages:
1. By using pectin as an additive for an aqueous phase solution of an interfacial polymerization reaction, the viscosity of the aqueous phase solution is increased, the diffusion rate of PMD to an organic phase is slowed down, and the depth of a miscible zone of the interfacial polymerization reaction is reduced, so that the thickness of a PA separating layer is decreased;
2. By weakening the interaction between the reaction monomers of the MPD in the aqueous phase solution, the dispersing uniformity of the MPD is improved, and the orderliness of the interfacial polymerization reaction and the entangling regularity of a polyamide high-molecular chain are improved, so that the stacking density of PA is improved, the pore size distribution is narrowed, and the porous structure is optimized;
3. Rich functional groups in the molecular structure of pectin can endow the PA separating layer with higher hydrophilicity and charging property, which is beneficial to further improving the permeation selectivity of the high-pressure reverse osmosis membrane;
4. Pectin is a typical anionic heteropolysaccharide, which widely exists in pericarps of oranges, lemons, and shaddocks, is low in cost, green, natural, and pollution-free, and meets the current environmental requirement and sustainable development idea;
5. The preparation method disclosed by the present disclosure is simple and easy to implement industrialization; as the interfacial assistant polymerizer, pectin is added into the aqueous solution, and the separating performance of the reverse osmosis membrane can be improved since pectin itself does not participate in the polymerization reaction; compared with other chemical modification methods, the preparation method is easy to operate and extra production processes and equipment are not needed;
6. Although the mass percent of pectin added in the preparation method disclosed by the present disclosure is less than 0.3 wt %, the performance of the reverse osmosis membrane is obviously improved.

### BRIEF DESCRIPTION OF THE DRAWINGS

FIG. 1 is an infra-red spectrogram of high-pressure reverse osmosis membranes obtained in Examples 2 and 5 and Comparative Examples 1 and 2;

FIG. 2 is a positron annihilation life time spectrogram of the high-pressure reverse osmosis membranes obtained in Examples 2 and 5 and Comparative Examples 1 and 2;

FIG. 3 is a surface scanning electron microscope image of the high-pressure reverse osmosis membrane obtained in Example 2;

FIG. 4 is a surface scanning electron microscope image of the high-pressure reverse osmosis membrane obtained in Example 5;

FIG. 5 is a sectional scanning electron microscope image of the high-pressure reverse osmosis membrane obtained in Example 2;

FIG. 6 is a sectional scanning electron microscope image of the high-pressure reverse osmosis membrane obtained in Example 5;

FIG. 7 is a surface scanning electron microscope image of the high-pressure reverse osmosis membrane obtained in Comparative Example 1;

FIG. 8 is a surface scanning electron microscope image of the high-pressure reverse osmosis membrane obtained in Comparative Example 2;

FIG. 9 is a sectional scanning electron microscope image of the high-pressure reverse osmosis membrane obtained in Comparative Example 1; and

FIG. 10 is a sectional scanning electron microscope image of the high-pressure reverse osmosis membrane obtained in Comparative Example 2.

### DESCRIPTION OF THE EMBODIMENTS

In order to make those skilled in the art understand the present disclosure more clearly, the present disclosure will be further described in detail below in conjunction with examples. However, it should be understood that the examples below are merely preferred implementations of the present disclosure, and the scope claimed by the present disclosure is not limited thereto.

An example of the present disclosure provides a method for preparing a high-pressure reverse osmosis membrane based on pectin-assisted interfacial polymerization, including the following steps:
(1) fixing a polysulfone ultrafiltration membrane to an organic glass frame, and draining off water drops on a surface of the polysulfone ultrafiltration membrane,
where a pure water permeation flux of the polysulfone ultrafiltration membrane at 0.1 MPa is 400-500 L·m⁻²·h⁻¹, and a bovine serum albumin retention rate of the polysulfone ultrafiltration membrane is 90.1-90.3%;
(2) pouring an aqueous solution containing metaphenylenediamine, camphorsulfonic acid, triethylamine and an interfacial polymerization reaction regulator onto the surface of the polysulfone ultrafiltration membrane, and removing a residual aqueous phase solution after allowing the polysulfone ultrafiltration membrane to stand for a period of time, wherein the interfacial polymerization reaction regulator is pectin, with a mass percent of 0.05-0.3 wt %;
where in the aqueous solution, a mass percent of metaphenylenediamine is 1.5-4 wt %, a mass percent of camphorsulfonic acid is 2-3.5 wt %, a mass percent of triethylamine is 0.8-2 wt %, the mass percent of pectin is 0.05-0.3 wt %, and a solvent for the aqueous solution is deionized water; preferably, in the aqueous solution of the example, a mass percent of metaphenylenediamine is 2.8 wt %, a mass percent of camphorsulfonic acid is 2.8 wt %, a mass percent of triethylamine is 1.3 wt %, the mass percent of the pectin is 0.05-0.3 wt %, and a solvent for the aqueous solution is deionized water,
where the polysulfone ultrafiltration membrane stands for 30-50 s; preferably, in the example, the polysulfone ultrafiltration membrane stands for 40 s;
(3) pouring an organic solution containing trimesoyl chloride onto the surface of the membrane obtained in step (2), and removing a residual organic phase solution from the surface after allowing the polysulfone ultrafiltration membrane to stand for a period of time,
where in the organic solution, a mass percent of trimesoyl chloride is 0.1-0.25 wt %, and a solvent for the organic solution is one or more of normal hexane, isopar G, isopar H, isopar L, and isopar M; preferably, in the organic solution in the example, a mass percent of trimesoyl chloride is 0.17 wt %, and a solvent for the organic solution is normal hexane,
where the polysulfone ultrafiltration membrane stands for 30-50 s; preferably, in the example, the polysulfone ultrafiltration membrane stands for 40 s;
(4) allowing the membrane obtained in step (3) to stand, putting the membrane in an air blast drying oven after the residual solution on the surface is naturally volatilized, performing a thermal treatment for a period of time at a specific temperature, and washing the surface of the membrane with deionized water to remove a residue from the surface to obtain the high-pressure reverse osmosis membrane,
where a temperature of the air blast drying oven is 80-120° C., and the thermal treatment is performed for 100-300 s; preferably, in the example, the temperature of the air blast drying oven is 95° C., and the thermal treatment is performed for 190 s.

In order to better understand the above implementations of the present disclosure, the implementations will be further described below in conjunction with specific examples.

In examples and comparative examples below:
Metaphenylenediamine, purchased from Shanghai Aladdin Biochemical Technology Co., Ltd., with a purity of 99 wt %;
camphorsulfonic acid, purchased from TCI (Shanghai) Development Co., Ltd., with a purity >98 wt %;
triethylamine, purchased from Tianjin Kemiou Chemical Reagent Co., Ltd., analytically pure;
pectin, purchased from Shanghai Aladdin Biochemical Technology Co., Ltd., galacturonic acid (based on dry basis)≥74.0%;
polysulfone ultrafiltration membrane: a pure water permeation flux of the polysulfone ultrafiltration membrane at 0.1 MPa is 400-500 L·m⁻²·h⁻¹, and a bovine serum albumin retention rate of the polysulfone ultrafiltration membrane is 90.1-90.3%;
trimesoyl chloride, purchased from Alfa Aesar, with a purity >98 wt. %;
normal hexane, purchased from Shanghai Aladdin Biochemical Technology Co., Ltd., analytically pure.

### Example 1

A method for preparing a high-pressure reverse osmosis membrane based on pectin-assisted interfacial polymerization includes the following steps:
(1) a polysulfone ultrafiltration membrane was fixed to an organic glass frame, and water drops on a surface of the polysulfone ultrafiltration membrane were drained off;
(2) an aqueous solution containing metaphenylenediamine, camphorsulfonic acid, triethylamine, and pectin was poured onto the surface of the polysulfone ultrafiltration membrane, and a residual aqueous phase solution was removed after the polysulfone ultrafiltration membrane was allowed to stand for 40 s, where a mass percent of metaphenylenediamine was 2.8 wt %, a mass percent of camphorsulfonic acid was 2.8 wt %, a mass percent of triethylamine was 1.3 wt %, and a mass percent of pectin was 0.05 wt %;
(3) a normal hexane solution containing trimesoyl chloride was poured onto the surface of the membrane obtained in step (2), and a residual organic phase solution on the surface was removed after the membrane was allowed to stand for 40 s, where the mass percent of trimesoyl chloride was 0.17 wt %; and
(4) the membrane obtained in step (3) was allowed to stand, the membrane was put in an air blast drying oven after the residual solution on the surface was naturally volatilized, a thermal treatment was performed for 190 s at 95° C., and the surface of the membrane was washed with deionized water to remove a residue from the surface to obtain the high-pressure reverse osmosis membrane.

### Example 2

A method for preparing a high-pressure reverse osmosis membrane based on pectin-assisted interfacial polymerization in Example 2 is different from Example 1 in that in step (2), the mass percent of pectin is 0.1 wt %, and other conditions remain unchanged.

### Example 3

A method for preparing a high-pressure reverse osmosis membrane based on pectin-assisted interfacial polymerization in Example 3 is different from Example 1 in that in step (2), the mass percent of pectin is 0.15 wt %, and other conditions remain unchanged.

### Example 4

A high-pressure reverse osmosis membrane based on pectin-assisted interfacial polymerization in Example 4 is different from Example 1 in that in step (2), the mass percent of pectin is 0.2 wt %, and other conditions remain unchanged.

### Example 5

A method for preparing a high-pressure reverse osmosis membrane based on pectin-assisted interfacial polymerization in Example 5 is different from Example 1 in that in step (2), the mass percent of pectin is 0.3 wt %, and other conditions remain unchanged.

### Comparative Example 1

A method for preparing a high-pressure reverse osmosis membrane based on pectin-assisted interfacial polymerization in Comparative Example 1 is different from Example 1 in that in step (2), pectin is not added, and other conditions remain unchanged.

### Comparative Example 2

A method for preparing a high-pressure reverse osmosis membrane based on pectin-assisted interfacial polymerization in Comparative Example 2 is different from Example 1 in that in step (2), the mass percent of pectin is 0.5 wt %, and other conditions remain unchanged.

### Comparative Example 3

A method for preparing a high-pressure reverse osmosis membrane based on pectin-assisted interfacial polymerization Comparative Example 3 is different from Example 1 in that in step (2), the mass percent of pectin is 1 wt %, and other conditions remain unchanged.

### Performance Test

In the present disclosure, the performance of the high-pressure reverse osmosis membranes prepared in Examples 1-5 and Comparative Examples 1-3 is tested by using a cross-flow filtration evaluation system.

The obtained membrane samples were placed in 3 parallel filtration units, and the effective area of a membrane pool was 28.46 cm². By using a NaCl aqueous solution with a concentration of 32000 mg/L as a feed liquid, the pH of the feed liquid was adjusted to 7.0+0.5. First, the high-pressure reverse osmosis membranes were pre-pressed at 5.52 MPa and 25±1° C. for 30 min, and then, a permeating fluid was collected at a filtration pressure of 5.52 MPa and a cross-flow flow of 6 L·min⁻¹.

The water permeation flux is calculated by Formula (1):

$${J}_{w} = \frac{Δ v}{S \cdot Δ t} \qquad ( 1 )$$

where J_{w} is a water permeation flux, with a unit of L·m⁻²·h⁻¹; S is an effective membrane area, with a unit of m²; Δt is a permeation time, with a unit of h; and Δv is a permeation water quantity collected within a certain time Δt, with a unit of L.

The NaCl retention rate R is calculated by Formula (2):

$$R \% = ( 1 - \frac{{c}_{P}}{{c}_{f}} ) \times 100 \% \qquad ( 2 )$$

where C_{P} is a NaCl concentration of a permeating fluid, with a unit of mg/L; and C_{f} is a NaCl concentration of a feed liquid, with a unit of mg/L.

The water permeability coefficient A and the salt permeability coefficient B can be respectively calculated by Formulae (3) and (4):

$$A = \frac{J w}{( Δ P - π )} \qquad ( 3 )$$

$$B = \frac{{J}_{w} ( 1 - R )}{R} \qquad ( 4 )$$

10 where A is the water permeability coefficient, with a unit of L·m⁻²·h⁻¹·bar⁻¹, B is the salt permeability coefficient, with a unit of L·m⁻²·h⁻¹; and ΔP and π are respectively a transmembrane pressure and an osmotic pressure of the feed liquid, with a unit of bar.

A test result is shown in Table 1.

TABLE 1
Characterization result and separating performance of high-pressure reverse osmosis membrane

| | | | Thickness of | | Water | NaCl | Salt | Permeation |
|---|---|---|---|---|---|---|---|---|
| | Water | Surface | separating | Permeation | permeability | retention | permeability | selectivity |
| | contact | Potential | layer | flux | coefficient A | rate | coefficient B | A/B |
| | angle | mV | nm | L · m⁻² · h⁻¹ | L · m⁻² · h⁻¹ · bar⁻¹ | % | L · m⁻² · h⁻¹ | bar⁻¹ |
| Example 1 | 67.65 | −46.68 | 255.48 | 68.71 | 2.47 | 99.41 | 0.41 | 6.06 |
| Example 2 | 65.12 | −47.52 | 251.87 | 77.68 | 2.79 | 99.40 | 0.47 | 5.95 |
| Example 3 | 63.91 | −48.35 | 245.37 | 78.19 | 2.81 | 99.47 | 0.42 | 6.74 |
| Example 4 | 62.34 | −49.11 | 239.44 | 79.63 | 2.86 | 99.49 | 0.41 | 7.01 |
| Example 5 | 60.72 | −49.83 | 234.98 | 80.15 | 2.88 | 99.57 | 0.35 | 8.32 |
| Comparative | 75.49 | −38.96 | 260.49 | 57.01 | 2.05 | 99.41 | 0.34 | 6.06 |
| Example 1 | | | | | | | | |
| Comparative | 60.35 | −50.33 | 207.37 | 69.66 | 2.50 | 97.22 | 1.99 | 1.26 |
| Example 2 | | | | | | | | |
| Comparative | 58.86 | −51.94 | 199.83 | 64.46 | 2.31 | 85.09 | 11.30 | 0.21 |
| Example 3 | | | | | | | | |

It can be known from data in Table 1 that in a case where the content of pectin is not higher than 0.3 wt % (Examples 1-5), the electronegativity of the high-pressure reverse osmosis membranes is gradually improved, and the NaCl retention rates are all greater than 99.4%; and in addition, the water contact angle is gradually decreased, the hydrophilicity is improved, and the water permeation flux is significantly improved, up to 80.15 L·m⁻²·h⁻¹. Particularly when the content of pectin is 0.3 wt %, the NaCl retention rate reaches up to 99.57%, the water permeation flux reaches up to 80.15 L·m⁻²·h⁻¹. Compared with the high-pressure reverse osmosis membrane without pectin (Comparative Example 1), the permeation flux is improved by 24.34%. Therefore, the effect of improving the water permeability, the desalination rate, the permeation selectivity are improved at the same time is achieved, breaking through the “Trade-off” effect between the permeation flux and the retention rate.

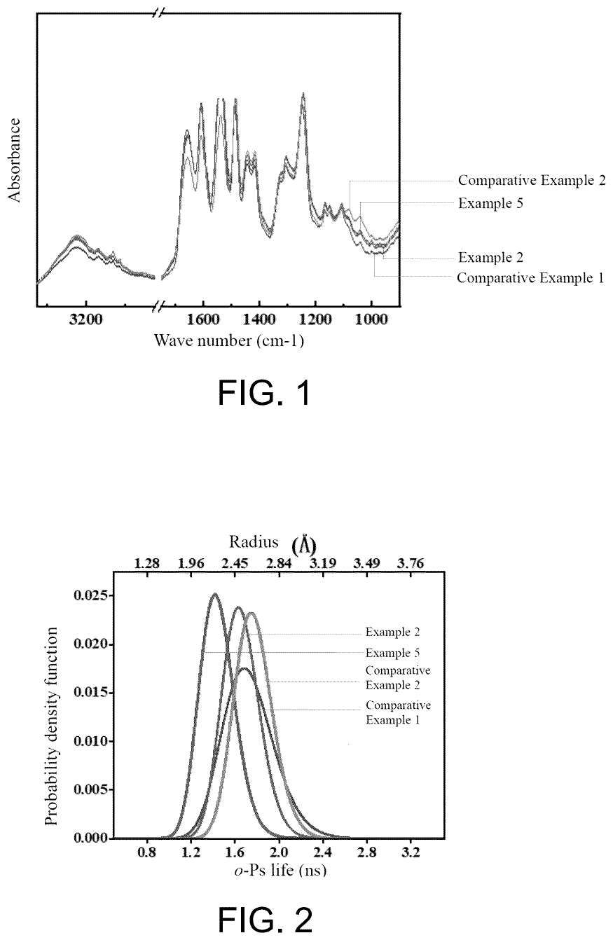

Infrared spectral characterization is performed on the PA separating layers of the high-pressure reverse osmosis membranes obtained in Examples 2 and 5 and Comparative Examples 1 and 2, as shown in FIG. 1. The characteristic absorption peaks of pectin are located at 3300 cm⁻¹ and 1047 cm⁻¹, where 3300 cm⁻¹ is induced by a stretching vibration of a O—H group, and 1047 cm⁻¹ is induced by a stretching vibration between a carbon atom and an oxygen atom in a α-1,4-glucosidic bond C—O—C. With a gradual increase in the concentration of pectin in the aqueous phase solution, the above two characteristic peaks in the Comparative Example 1, Example 2, Example 5, and Comparative Example 2 are increased gradually, indicating that pectin is doped in the PA layer. Since pectin has good hydrophilicity and rich carboxyl functional groups, the hydrophilicity and electronegativity of the high-pressure reverse osmosis membranes obtained in Examples 1-5 are gradually improved.

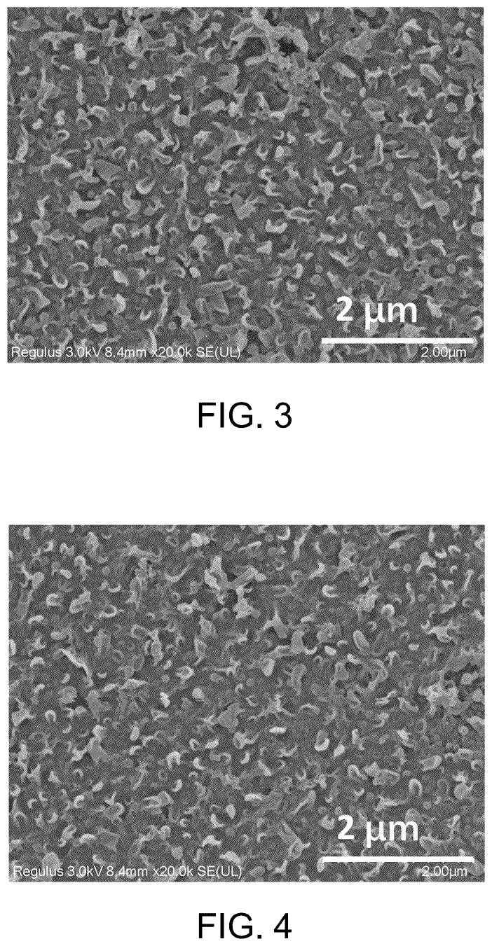

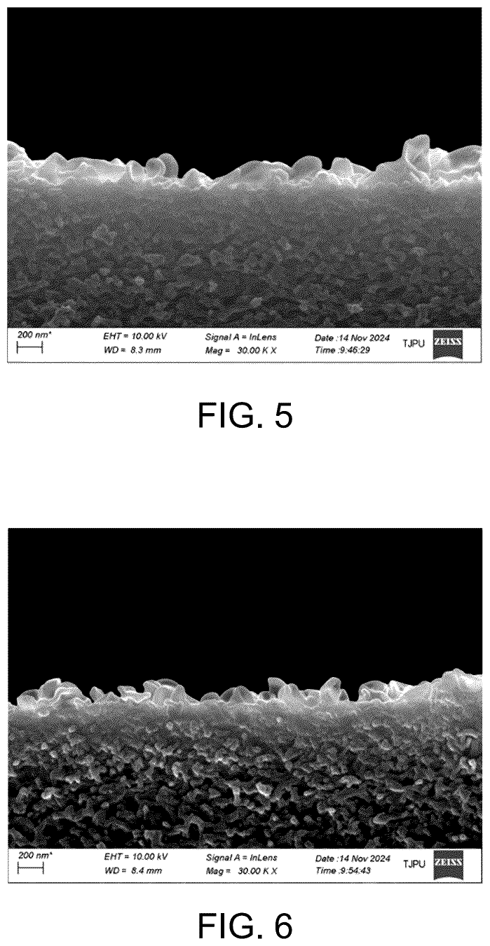

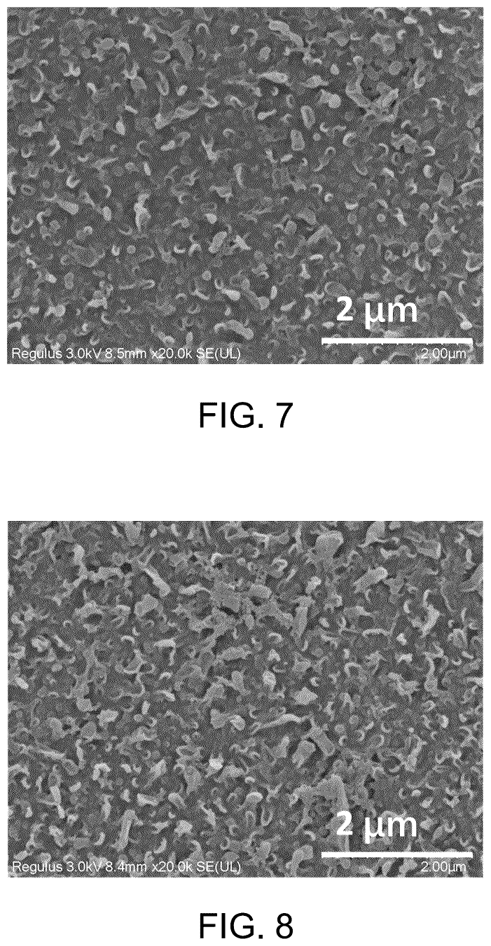

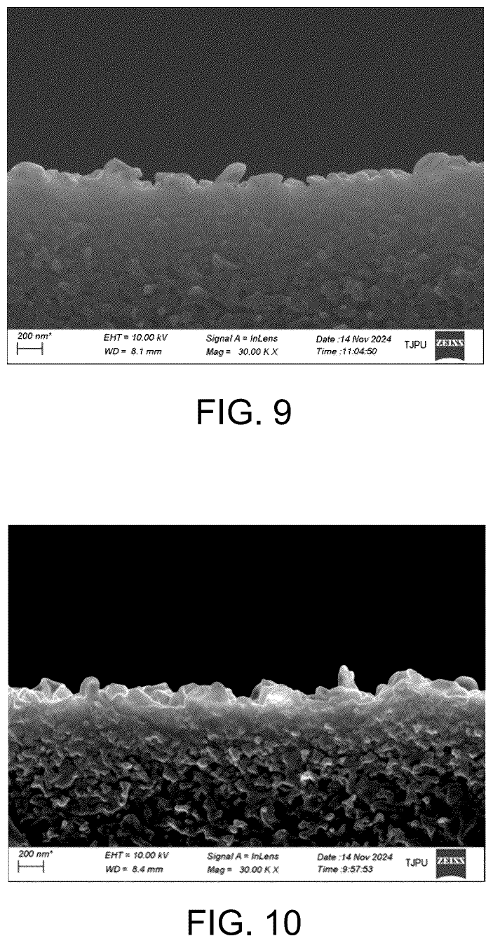

The surface and section morphology of the high-pressure reverse osmosis membranes obtained in Examples 2 and 5 and Comparative Examples 1 and 2 are analyzed, with scanning electron microscope images shown in FIGS. 3-10. As shown in FIGS. 3, 4, 7, and 8, typical leaf-like structures of PA are formed on the surfaces of the high-pressure reverse osmosis membranes, and the surface morphology has no obvious change. As shown in FIGS. 5, 6, 9, and 10, the sectional shapes of the high-pressure reverse osmosis membranes are similar. As shown in FIG. 9, the thickness of the PA separating layer of the high-pressure reverse osmosis membrane obtained in Comparative Example 1 is about 260.49 nm; as shown in FIGS. 5, 6, and 10, the thicknesses of the PA separating layers of the high-pressure reverse osmosis membranes obtained in Example 2, Example 5, and Comparative Example 2 are gradually decreased, which are respectively 251.87 nm, 234.98 nm, and 207.37 nm. By introducing pectin, the viscosity of the aqueous phase solution is gradually increased, the diffusion rate is slowed down, and the thickness of the PA separating layer is gradually decreased, which promotes the improvement of the water permeation flux. The introduction of pectin into the aqueous phase does not obviously change the morphology of the membrane surface, and the PA layer is thinned, so that the water permeation flux is greatly improved.

In addition, the interaction energy between MPD and MPD molecules and the interaction energy between pectin molecules and MPD molecules are respectively calculated under conditions of different pectin adding amounts, where the calculation formula is as follows:

$${E}_{int} = {E}_{A + B} - ( {E}_{A} + {E}_{B} ) \qquad ( 5 )$$

where Eᵢₙₜ is the interaction energy between MPD molecules and pectin molecules, E_{A+B} is the total energy of a MPD-pectin conjugate, E_{A} is the energy of MPD molecules in the conjugate, and E_{B} is the energy of pectin molecules in the conjugate, with a unit of kcal/mol.

Test results are shown in Table 2.

TABLE 2
Interaction energy between MPD and MPD molecules
and interaction energy between pectin molecules
and MPD molecules under conditions of different
pectin adding amounts

| | EA + B | EA | EB | Eint |
|---|---|---|---|---|
| | (kcal/mol) | (kcal/mol) | (kcal/mol) | (kcal/mol) |
| MPD-MPD | −70.87 | −31.12 | −31.12 | −8.63 |
| (Without pectin) | | | | |
| MPD-MPD | −60.21 | −28.35 | −27.87 | −3.99 |
| (Containing a small | | | | |
| amount of pectin) | | | | |
| Pectin-MPD | −14.96 | −30.86 | 44.24 | −28.34 |
| (Containing a small | | | | |
| amount of pectin) | | | | |
| MPD-MPD | −51.94 | −25.59 | −28.42 | 2.07 |
| (Containing a large | | | | |
| amount of pectin) | | | | |
| Pectin-MPD | −17.98 | −30.83 | 36.41 | −23.56 |
| (Containing a large | | | | |
| amount of pectin) | | | | |

By molecular simulation, calculated results are shown in Table 2. The interaction energy between pectin and MPD is a negative value, indicating that there is mutual attraction therebetween. With the increase in the content of pectin, the viscosity of the aqueous phase solution is gradually increased, which hinders the interaction between pectin and MPD. The attraction between pectin and MPD is weakened, which is decreased from 28.34 kcal/mol to 23.56 kcal/mol. At the same time, the T-x interaction force between MPD and MPD is gradually weakened due to the increase in the viscosity of the aqueous phase solution. The attraction is decreased from 8.63 kcal/mol to 3.99 kcal/mol, which means that the dispersing uniformity of the MPD molecules in the aqueous phase solution is improved.

Positron annihilation life time spectral characterization is performed on the PA separating layers of the high-pressure reverse osmosis membranes obtained in Examples 2 and 5 and Comparative Examples 1 and 2, as shown in FIG. 2. Due to a weaker interaction force between the MPD molecules, compared with the high-pressure reverse osmosis membrane (Comparative Example 1) without pectin, the high-pressure reverse osmosis membranes obtained in Examples 2 and 5 have a narrower pore size distribution, and the radius of free volume is gradually decreased with the increase in the concentration of pectin. However, due to a large amount of carboxyl in the molecular structure of pectin, when the adding amount is large, the amino groups in the MPD molecules are protonized. Due to the mutual repulsive force (2.07 kcal/mol) between the protonized MPD molecules, the radius of the free volume of the membrane in Comparative Example 2 is increased on the contrary. Therefore, when the content of pectin reaches or is higher than 0.5 wt % (Comparative Examples 2 and 3), the permeation flux and NaCl retention rate are both significantly reduced. To sum up, when the adding amount of pectin is low, with the introduction of pectin, the viscosity of the aqueous phase solution is increased, the interaction force between the MPD molecules is weakened, and the dispersibility of MPD is improved, so that the pore size distribution of the PA layer is narrowed, the radius of free volume is decreased, and the salt retention rate is increased. By using natural high-molecular pectin as the additive, when the concentration of pectin is not greater than 0.3 wt %, the permeation flux of the high-pressure reverse osmosis membrane can be greatly improved while the NaCl retention rate is guaranteed. The high-pressure reverse osmosis membrane prepared in the present disclosure can be applied to processes such as seawater desalination and high-salinity industrial wastewater treatment.

It should be noted finally that the above examples are merely used to describe the technical solutions of the present disclosure, rather than limiting the same; although the present disclosure is described in detail with reference to the above examples, those of ordinary skill in the art should understand that they still can modify the technical solutions recorded in the above examples or equivalently replace part of all the technical features therein; and these modifications or replacements do not make the essence of corresponding technical solutions deviated from the scope of the technical solutions of the examples of the present disclosure.

What is claimed is:

1. A method for preparing a high-pressure reverse osmosis membrane based on pectin-assisted interfacial polymerization, comprising the following steps:
(1) fixing a polysulfone ultrafiltration membrane to an organic glass frame, and draining off water drops on a surface of the polysulfone ultrafiltration membrane;
(2) pouring an aqueous solution containing metaphenylenediamine, camphorsulfonic acid, triethylamine and an interfacial polymerization reaction regulator onto the surface of the polysulfone ultrafiltration membrane, and removing a residual aqueous phase solution from the surface of the polysulfone ultrafiltration membrane, after allowing the polysulfone ultrafiltration membrane to stand for a period of time, wherein the interfacial polymerization reaction regulator is pectin, with a mass percent of 0.05-0.3 wt %;
(3) pouring an organic solution containing trimesoyl chloride onto the surface of the membrane obtained in step (2), and removing a residual organic phase solution from the surface after allowing the polysulfone ultrafiltration membrane to stand for a period of time; and
(4) allowing the membrane obtained in step (3) to stand, putting the membrane in an air blast drying oven after the residual solution on the surface is naturally volatilized, performing a thermal treatment for a period of time at a specific temperature, and washing the surface of the membrane with deionized water to remove a residue from the surface to obtain the high-pressure reverse osmosis membrane.

2. The method for preparing a high-pressure reverse osmosis membrane based on pectin-assisted interfacial polymerization according to claim 1, wherein in step (1), a pure water permeation flux of the polysulfone ultrafiltration membrane at 0.1 MPa is 400-500 L·m⁻²·h⁻¹, and a bovine serum albumin retention rate of the polysulfone ultrafiltration membrane is 90.1-90.3%.

3. The method for preparing a high-pressure reverse osmosis membrane based on pectin-assisted interfacial polymerization according to claim 1, wherein in the aqueous solution in step (2), a mass percent of metaphenylenediamine is 1.5-4 wt %, a mass percent of camphorsulfonic acid is 2-3.5 wt %, a mass percent of triethylamine is 0.8-2 wt %, the mass percent of pectin is 0.05-0.3 wt %, and a solvent for the aqueous solution is deionized water.

4. The method for preparing a high-pressure reverse osmosis membrane based on pectin-assisted interfacial polymerization according to claim 1, wherein in step (2), the polysulfone ultrafiltration membrane stands for 30-50 s.

5. The method for preparing a high-pressure reverse osmosis membrane based on pectin-assisted interfacial polymerization according to claim 1, wherein in the organic solution in step (3), a mass percent of trimesoyl chloride is 0.1-0.25 wt %, and a solvent for the organic solution is one or more of normal hexane, isopar G, isopar H, isopar L, and isopar M.

6. The method for preparing a high-pressure reverse osmosis membrane based on pectin-assisted interfacial polymerization according to claim 1, wherein in step (3), the polysulfone ultrafiltration membrane stands for 30-50 s.

7. The method for preparing a high-pressure reverse osmosis membrane based on pectin-assisted interfacial polymerization according to claim 1, wherein in step (4), a temperature of the air blast drying oven is 80-120° C., and the thermal treatment is performed for 100-300 s.

8. A high-pressure reverse osmosis membrane based on pectin-assisted interfacial polymerization, prepared by the method for preparing a high-pressure reverse osmosis membrane based on pectin-assisted interfacial polymerization according to claim 1.

9. The high-pressure reverse osmosis membrane based on pectin-assisted interfacial polymerization according to claim 8, wherein the 32000 mg/L NaCl retention rate at 5.52 MPa of the high-pressure reverse osmosis membrane reaches 99.57%, and the permeation flux reaches 80.15 L·m⁻²·h⁻¹.

10. Use of the high-pressure reverse osmosis membrane based on pectin-assisted interfacial polymerization according to claim 8, wherein the high-pressure reverse osmosis membrane is applied to processes sea water desalination and high-salinity industrial wastewater treatment.
